(19) United States
(12) Patent Application Publication
(10) Pub. No.: US 2020/0254898 A1
(43) Pub. Date: Aug. 13, 2020

(54) Systems and Methods for Battery Charge Replenishment in an Electric Vehicle

(71) Applicant: Tara Chand Singhal, Torrance, CA (US)

(72) Inventor: Tara Chand Singhal, Torrance, CA (US)

(21) Appl. No.: 15/776,223

(22) PCT Filed: Dec. 12, 2016
(86) PCT No.: PCT/US16/66195

§ 371 Date: May 15, 2018

Related U.S. Application Data
(60) Provisional application No. 62/266,635, filed on Dec. 13, 2015.
(60) Provisional application No. 62/272,051, filed on Dec. 28, 2015.
(60) Provisional application No. 62/307,441, filed on Mar. 12, 2016.
(60) Provisional application No. 62/322,797, filed on Apr. 15, 2016.
(60) Provisional application No. 62/356,041, filed on Jun. 29, 2016.

(51) Int. Cl. B60L 53/80; B60L 50/64; B60L 50/60; H01M 2/10

(52) U.S. Cl. CPC B60L 53/80; B60L 50/64; B60K 2001/0461; H01M 2/1083; B60L 50/66

(57) ABSTRACT

System and methods for improvements in the areas of, electrical vehicle range, availability of charging stations and charging time required for electric vehicles (10A) are described. The embodiments described herein use a modular battery (22) structure that makes it convenient and easy by a driver to be able to remove spent or discharged battery modules (22) individually in the electric vehicle (10A) and replace them with fresh or charged modules (22) that would be available at any gas station (70) or a vending station (38) specifically for such battery modules (22).

### CROSS REFERENCE

This application claims priority on U.S. Provisional Application Ser. No. 62/266,635, titled “Systems and Methods for Battery Charge Replenishment in an Electric Vehicle” filed on Dec. 13, 2015, by Tara Chand Singhal. The contents of the Provisional Application Ser. No. 62/266,635 are incorporated herein by reference.

This application claims priority on U.S. Provisional Application Ser. No. 62/272,051, titled “Systems and Methods for Battery Charge Replenishment in an Electric Vehicle” filed on Dec. 28, 2015, by Tara Chand Singhal. The contents of the Provisional Application Ser. No. 62/272,051 are incorporated herein by reference.

This application claims priority on U.S. Provisional Application Ser. No. 62/307,441, titled “Systems and Methods for Battery Charge Replenishment in an Electric Vehicle” filed on Mar. 12, 2016, by Tara Chand Singhal. The contents of the Provisional Application Ser. No. 62/307,441 are incorporated herein by reference.

This application claims priority on U.S. Provisional Application Ser. No. 62/322,797, titled “Systems and Methods for Battery Charge Replenishment in an Electric Vehicle” filed on Apr. 15, 2016, by Tara Chand Singhal. The contents of the Provisional Application Ser. No. 62/322,797 are incorporated herein by reference.

This application claims priority on U.S. Provisional Application Ser. No. 62/356,041, titled “Systems and Methods for Battery Charge Replenishment in an Electric Vehicle” filed on Jun. 29, 2016, by Tara Chand Singhal. The contents of the Provisional Application Ser. No. 62/356,041 are incorporated herein by reference.

### FIELD OF THE INVENTION

System and methods for improvements in electric cars in the areas of range, charging time and availability of charging stations are described.

### BACKGROUND

Since the advent of the electric cars designed and manufactured by Tesla, a few years ago, there has been resurgence in the research and development of electric vehicles by most major auto manufacturer in the USA as well as in other countries such as Germany and Japan.

However, there are multiple issues yet to be resolved in electric cars before there would a wide-spread adoption of electric cars by drivers in the electric vehicle market place. These issues are cost of Lithium Ion batteries, limited range of electric cars, limited availability of charging stations, and charging time required for charging electric car batteries.

Many companies are working on addressing some or all of these issues. As an illustration, Tesla is working on mass producing lithium ion batteries and thus reducing the cost of such batteries for use in electric vehicles. Panasonic is working to increase the supply of such lithium ion batteries to meet the expected demand for use of these batteries in electric vehicles.

For electric cars, it is believed, there is a need for improvements in some of these other issues such as, vehicle range, charging time required for charging the batteries and ready availability of charging stations.

Hence, it is an objective of the embodiments herein to provide for apparatus, systems, and methods to address these other issues of range, availability of charging stations and charging time.

### SUMMARY

Apparatus, systems, and methods for improvements in the areas of, electrical vehicle range, availability of charging stations, and charging time required for electric vehicles are described.

Tesla chose to use standard Li-ion cells of 1.5 Volt and use a large quantity of them and position these cells in the floor space of the electric car. Tesla also focused on initially producing, instead of an economy electric vehicle, a large luxury sedan that would compete with high class European cars.

Tesla also focused on producing a large luxury sedan with a range of around 240 to 300 miles. These Tesla decisions set Tesla electric cars apart from attempts at manufacturing electric cars by other auto manufacturers and it is believed were a foundation of the success that Tesla cars have enjoyed in the electric car marketplace.

That approach of using standard available lithium ion batteries in electric vehicles manufactured by Tesla provided several advantages for the electric vehicles such as range as well as better use of space inside the electric vehicle, among other advantages.

A lithium-ion battery, sometimes also referred to a Li-ion battery or LIB, is a member of a family of rechargeable battery types in which lithium ions move from the negative electrode to the positive electrode during discharge and back when charging.

Li-ion batteries use an intercalated lithium compound as one electrode material, compared to the metallic lithium used in a non-rechargeable lithium battery. The electrolyte, which allows for ionic movement, and the two electrodes are the constituent components of a lithium-ion battery cell.

Lithium-ion batteries are common in consumer electronics. They are one of the most popular types of rechargeable batteries for portable electronics, with a high energy density, tiny memory effect and low self-discharge. Beyond consumer electronics, LIBs are also growing in popularity for military use and aerospace applications.

From a published source: If Tesla meets its goal of shipping 40,000 Model S electric cars in 2014 and if the 85-kWh battery, which uses 7,104 of these cells, proves as popular overseas as it was in the U.S., in 2014 the Model S alone would use almost 40 percent of global cylindrical battery production.

Production is gradually shifting to higher-capacity 3,000+mAh cells. Annual flat polymer cell demand was expected to exceed 700 million in 2013. In 2015 cost estimates ranged from $300-500/kwh.

Thus the cost of Li-ion cells per electric car is approximately 85 KWh multiplied by $400 (average of $300-$500)=$35,000. This cost of cells directly impacts the cost of the Tesla electric cars.

Therefore to lower the cost of this aspect of an electric car, as well as to increase supply of these Li-ion cells, based on published news, Tesla has been engaged in lowering the cost of production of these Li-Ion battery cells by building a Giga factory in Nevada with the help of International Partners such as Panasonic for the mass production of these Li-Ion cells.

However, Tesla has not solved the infrastructure issues of ready availability of charging stations and charging time required to charge an electric card. These issues, it is believed, make it harder for people to adopt electric cars compared to the gasoline powered cars they now drive and are used to.

Hence new technologies that would make electric cars comparable to gasoline powered cars in areas such as refueling convenience, including reduced charging time and ready availability of charging stations, as well as range that would come from refueling convenience are needed.

Then it is believed, people would readily adopt use of electric cars and find them equally versatile and convenient to use as a current hybrid or a gasoline powered vehicle. This would ensure wide scale adoption of electric cars with measurable environmental benefits.

The embodiments described herein make possible an electric powered car to be just like a gasoline powered car, with respect to charging time, availability of charging stations and range.

The embodiments described herein use a modular battery structure that makes it convenient and easy by a driver to be able to remove spent or discharged battery modules individually in the electric vehicle and replace them with fresh or charged modules that would be available at any gas station or a vending station specifically for such battery modules.

The embodiments described herein are not intended to replace charging at home or charging at prior charge stations provided by a city or by Tesla for Tesla cars. Instead the embodiments described herein provide a degree of flexibility, practicality, and freedom to commute locally or long distance in an electric vehicle without issues of range, availability of charge stations, and charging time.

These and other aspects of the embodiments herein are further described in detail with the help of the accompanying drawings and the description, where similar number are used to identify the features of the embodiments.

### BRIEF DESCRIPTION OF THE DRAWINGS

Some of the novel features of the embodiments will be best understood from the accompanying drawings, taken in conjunction with the accompanying description, in which similar reference characters refer to similar parts, and in which:

FIGS. 1A and 1B are an embodiment of a battery compartment in the floor of an electric vehicle and access doors for access to the battery compartment;

FIG. 1C is an embodiment of a battery module for use in the battery compartment in an electric car;

FIG. 1D is an embodiment of logic for sequential use of battery modules in the electric car;

FIG. 1E is an embodiment of display panels for assessing the battery modules and available driving distance in an electric car;

FIG. 2A is an embodiment of a vending system for vending battery modules for use in an electric car;

FIG. 2B is an embodiment of logic for use in the vending system for charging battery modules in the vending station for use in an electric car;

FIG. 3A is an embodiment of a method of replacing battery modules from the vending system to the electric car;

FIG. 3B is an embodiment of a method of using the vending system for replacing battery modules from the vending system to the electric car;

FIG. 3C is an embodiment of a visual illustration of the vend system and use of battery compartment for replacing battery modules in the electric car;

FIG. 3D is an embodiment of a visual illustration of the display of status panels in the electric car after battery module replacement in the electric car;

FIG. 4 is an embodiment of a method for replenishing batteries in an electric car;

FIGS. 5A, 5B and 5C are an embodiment of a visual illustration of a satellite based central system that may be used to manage the system of replenishing the battery modules in the vend system and the electric car;

FIG. 6A is an embodiment of positioning battery modules in the front of the vehicle in an engine compartment accessible by gull wing style access panels;

FIG. 6B is an embodiment of a battery replenishment system using a robotic arm to replace battery modules in the engine compartment; and

FIG. 6C is a computer system for automatic battery module replacement.

FIG. 7A is an embodiment of a battery replenishment system using semi-automated vending system for replacing battery modules in the vehicle; and

FIG. 7B is method for an embodiment of a battery replenishment system for semi-automatic battery module replacement.

### DESCRIPTION

### Introduction

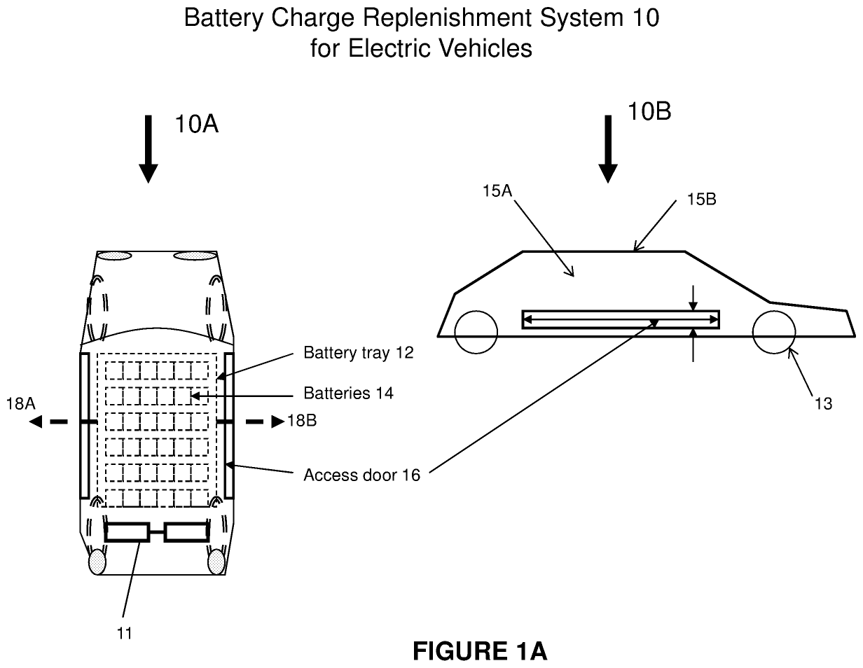

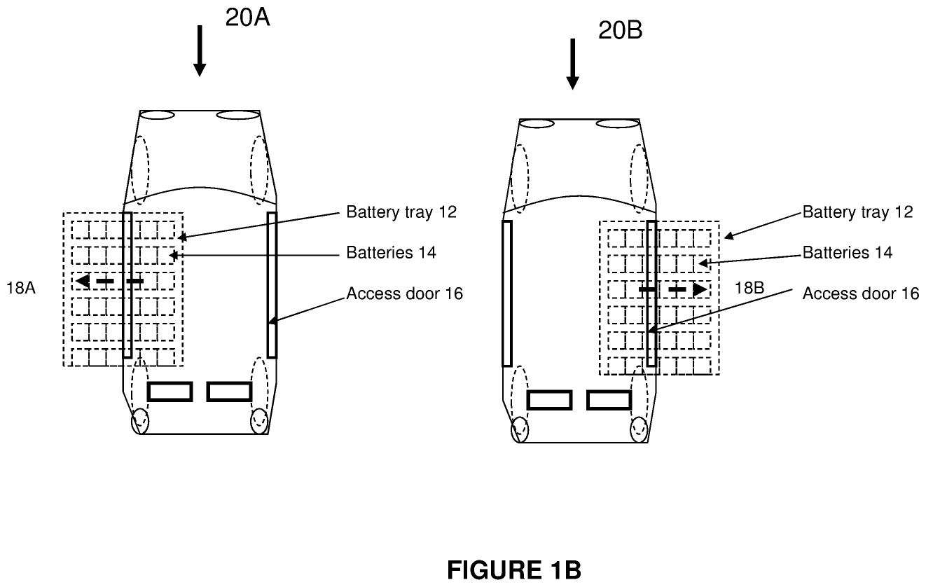

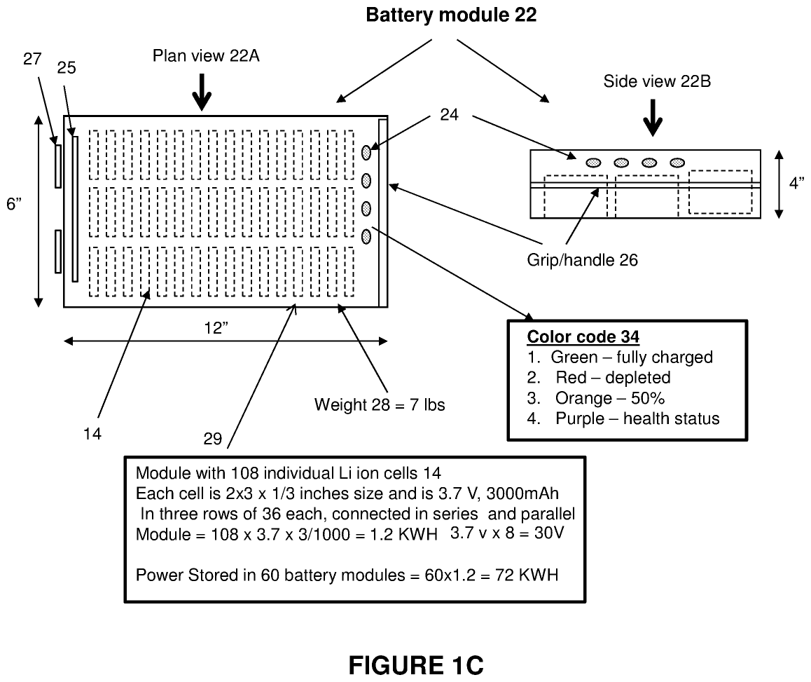

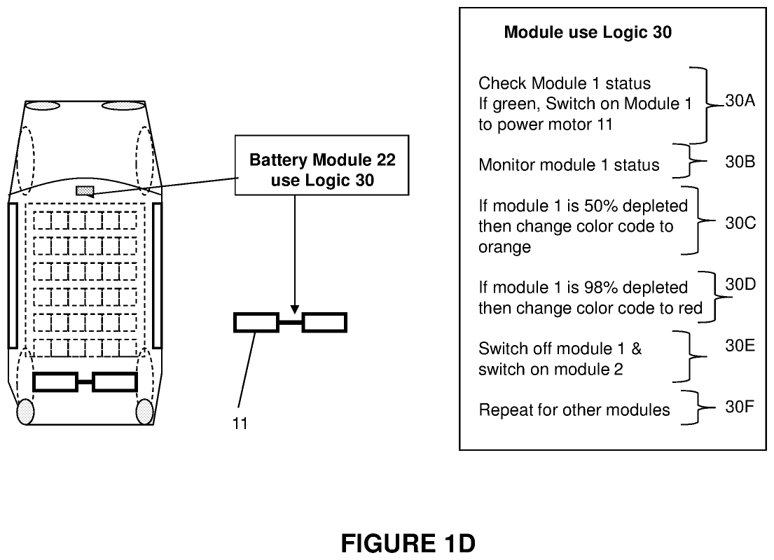

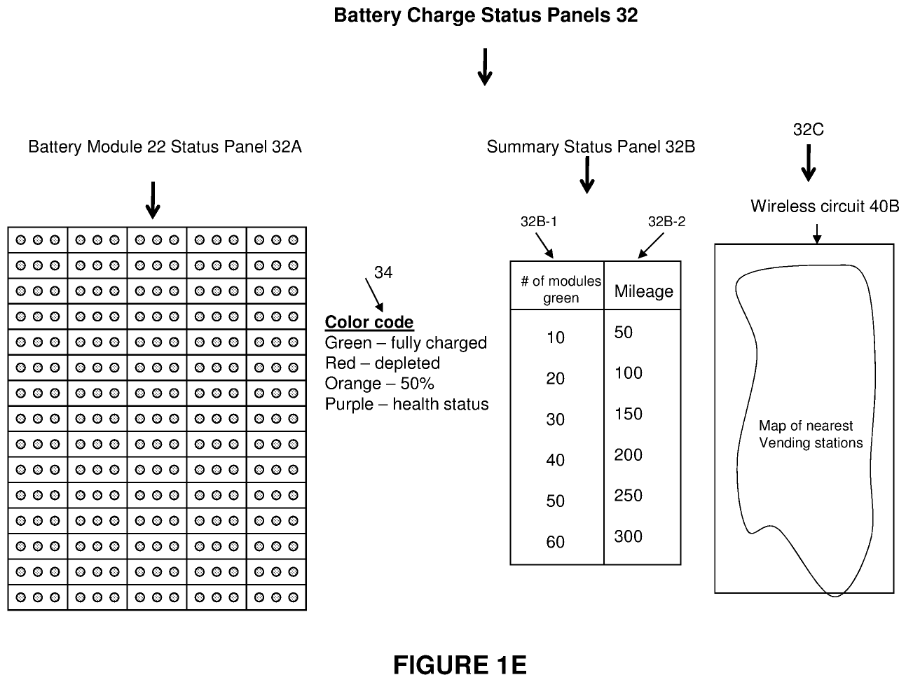

With reference to FIGS. 1A, 1B, 10, 1D, and 1E, a modular battery system for use in electric powered road vehicles is described. The terms vehicle, electric vehicle and electric car are used interchangeably to mean an electric powered road vehicle.

The modular battery system comprising a large number of battery modules enables individual battery modules to be easily accessed and removed from the vehicle and replaced with charged battery modules at gas stations and other locations that would provide a battery module vending system.

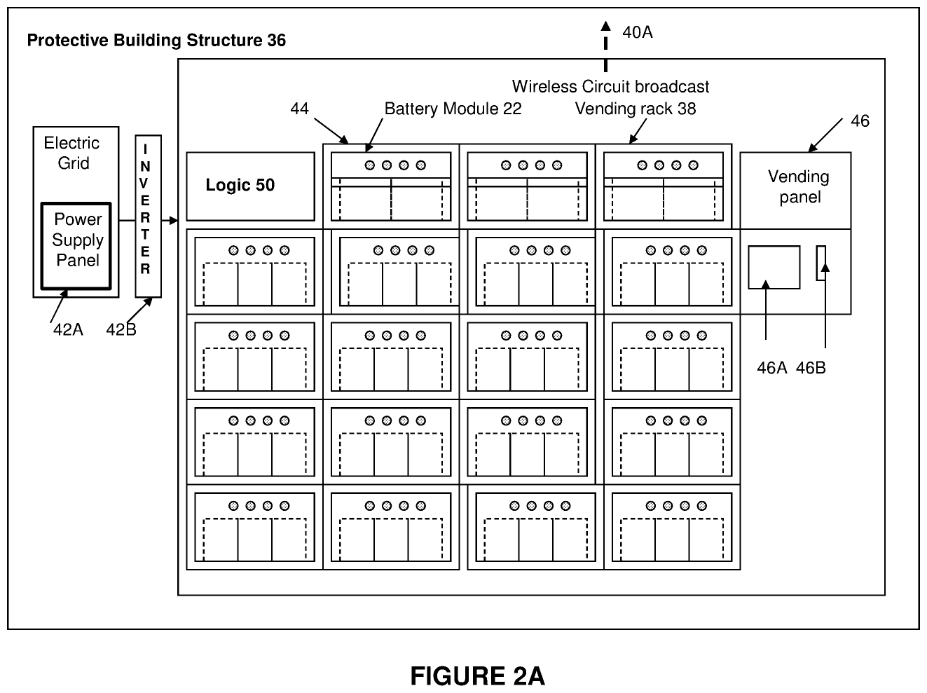

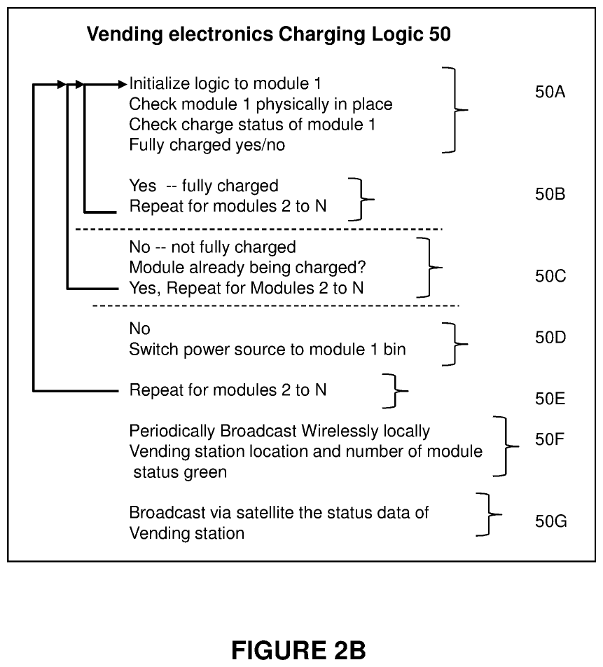

With reference to FIGS. 2A, and 2B, a vending system for vending charged battery modules is described. The vending system enables the discharged battery modules to be exchanged with charged battery modules and the vending system then charges these battery modular for other drivers for their electric vehicles.

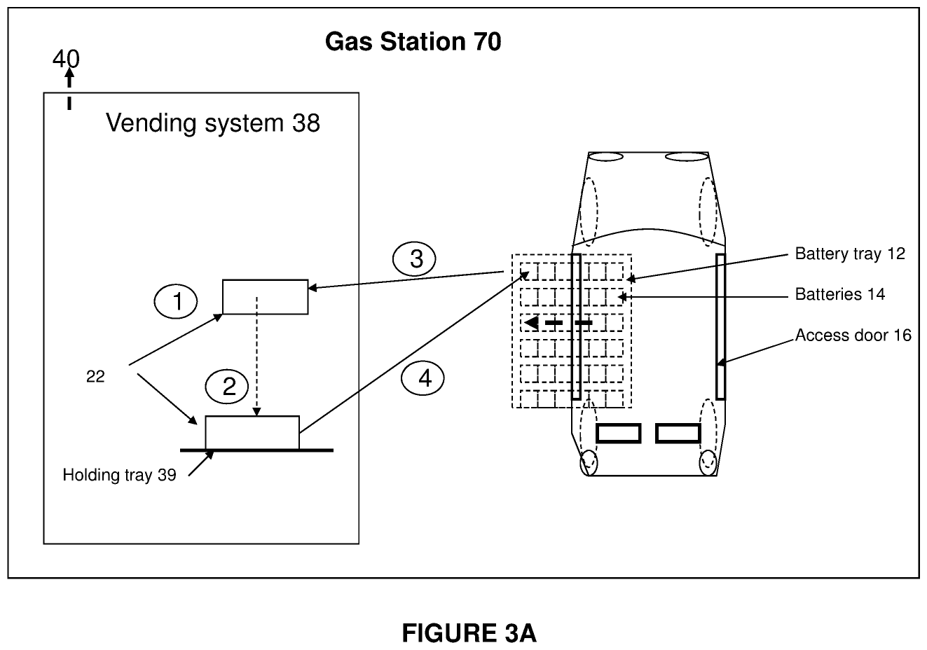

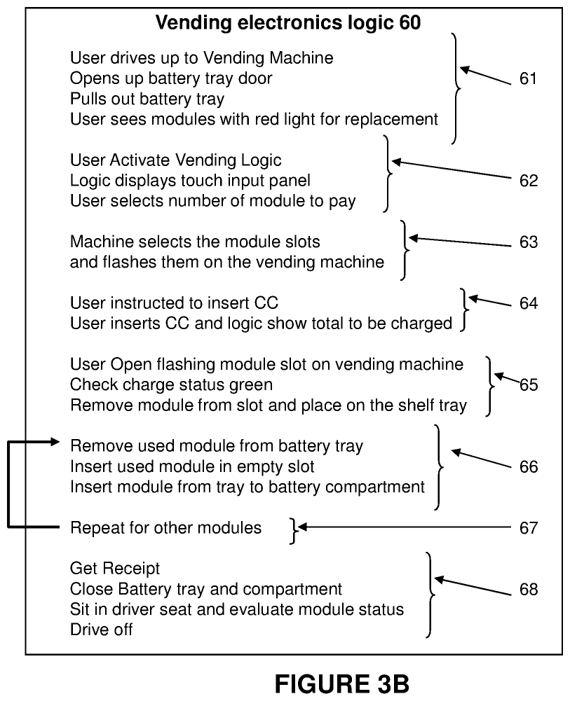

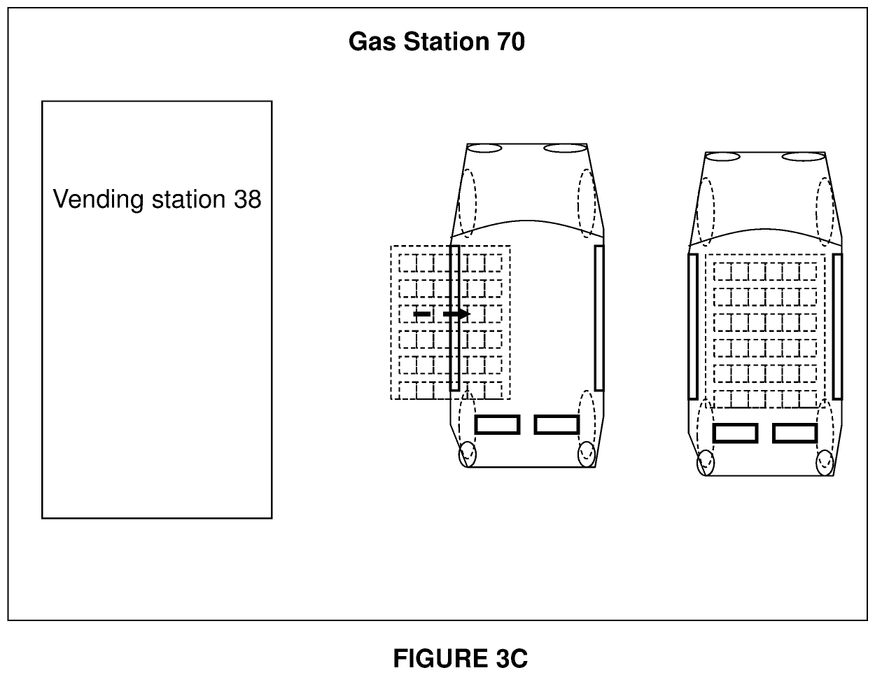

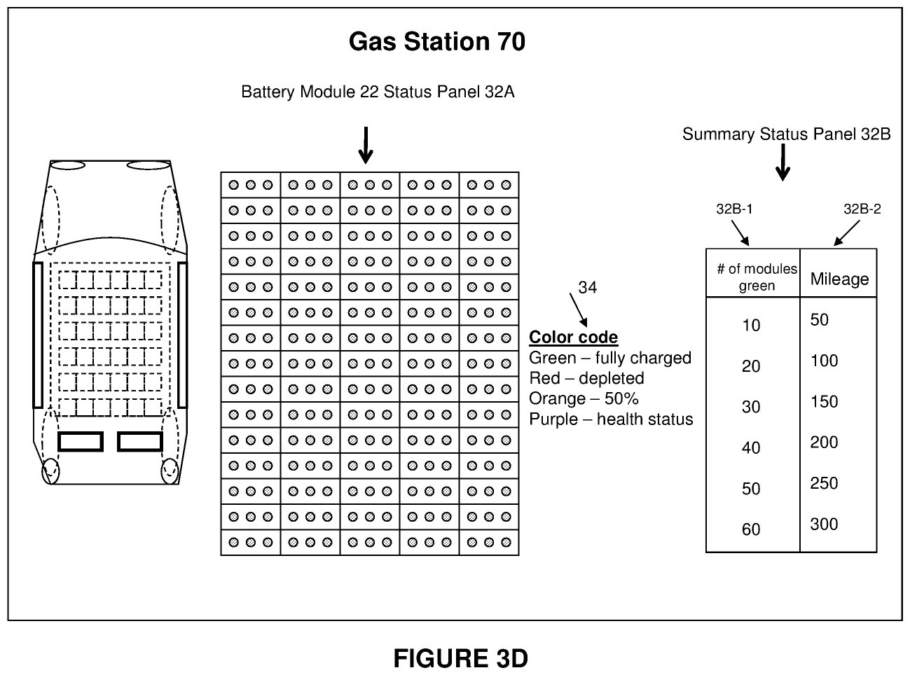

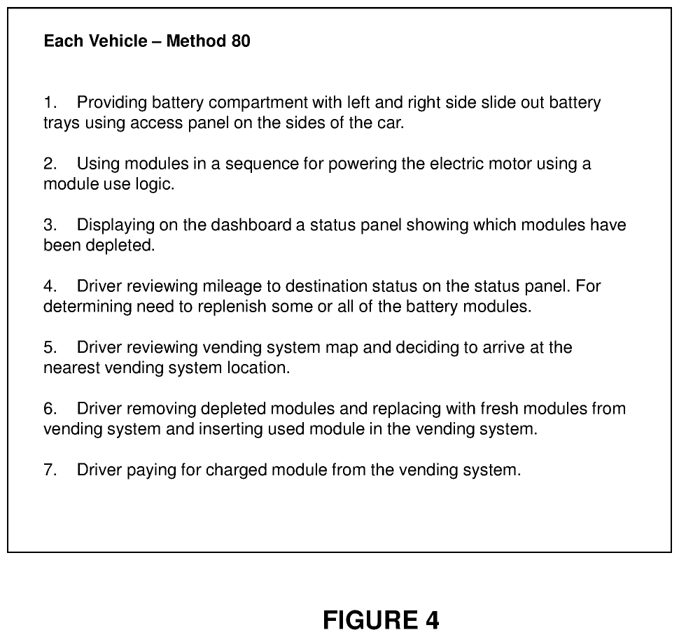

With reference to FIGS. 3A, 3B, 3C, 3D and FIG. 4, a system for charge replenishment of these battery modules for use in electric cars is described. The system as described with the help of these figures makes it convenient for such battery modules to be used in electric road vehicles, and replaced with charged battery modules at the vending system.

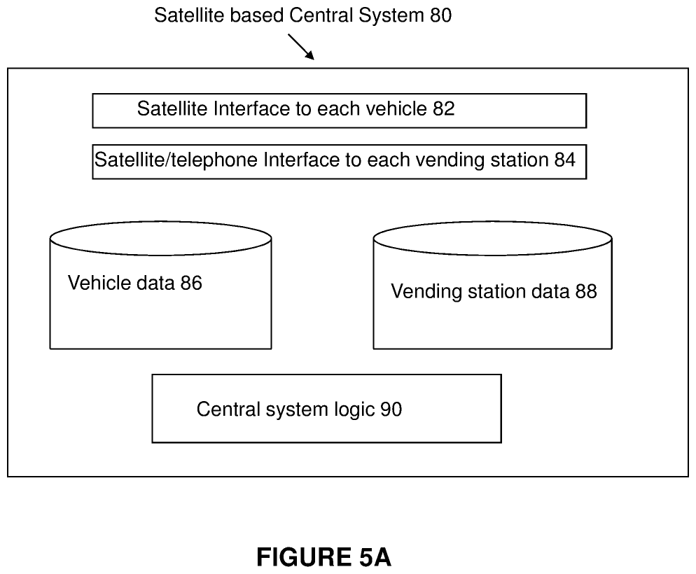

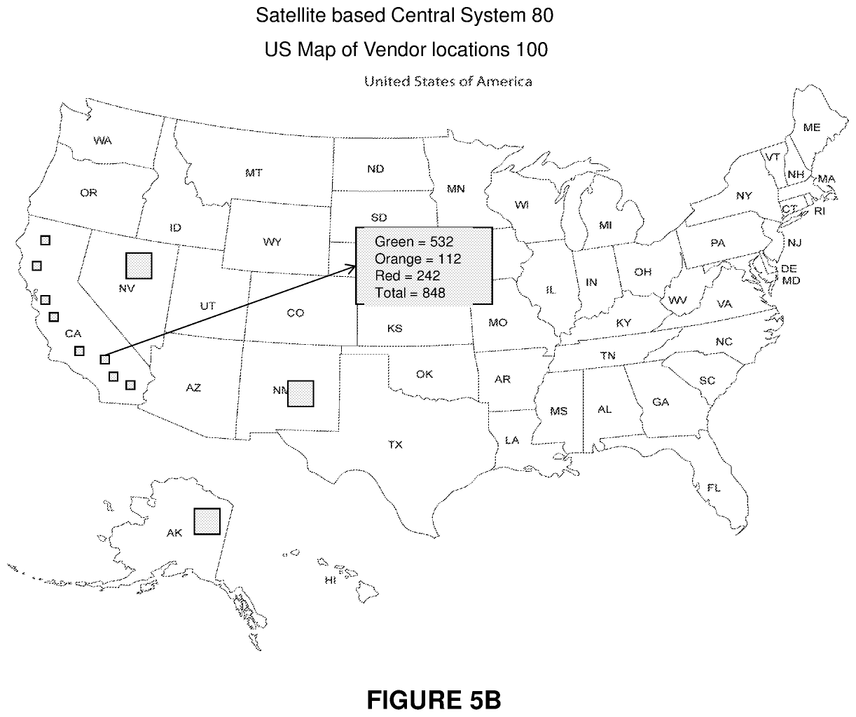

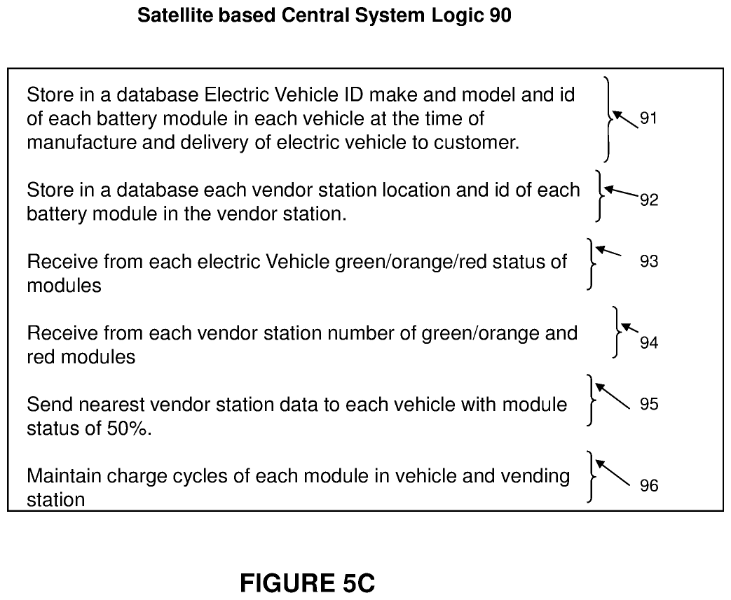

With reference to FIGS. 5A, 5B, and 5C, a satellite-based system that may be advantageously used for centrally managing and maintaining these vending systems for maintenance of battery module vending systems as well as electric cars is described.

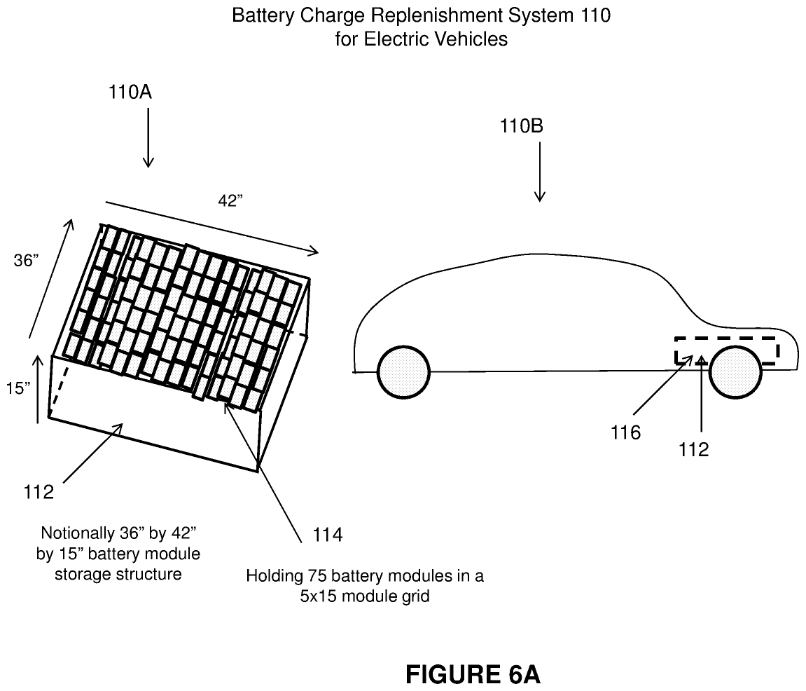

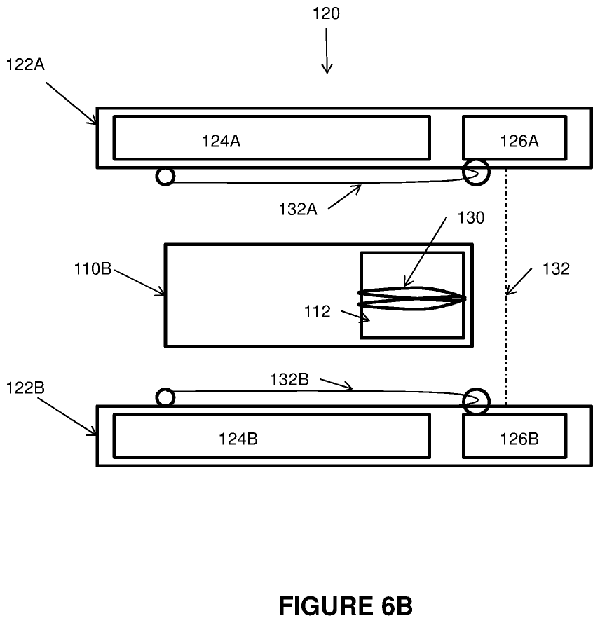

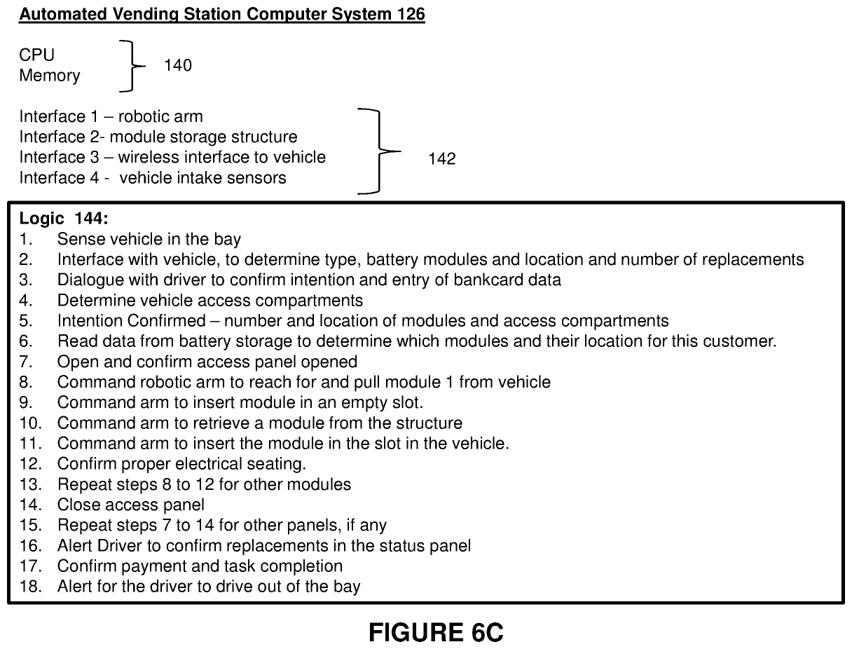

With reference to FIGS. 6A, 6B and 6C, an automated vending system is described that can replenish the spent battery modules in the electric road vehicle using a robot driven system without driver interaction.

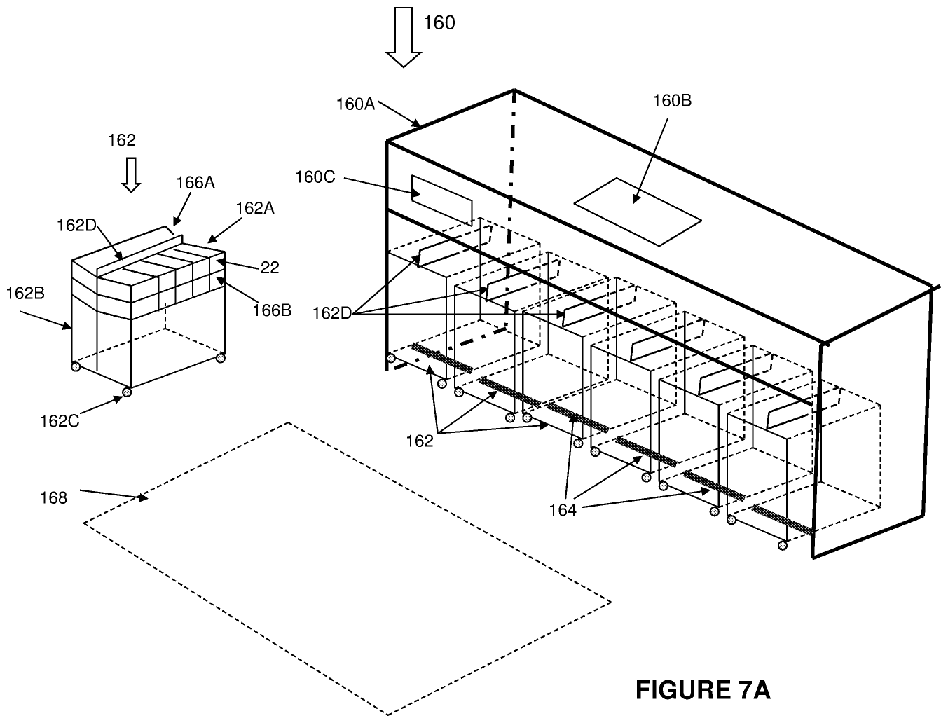

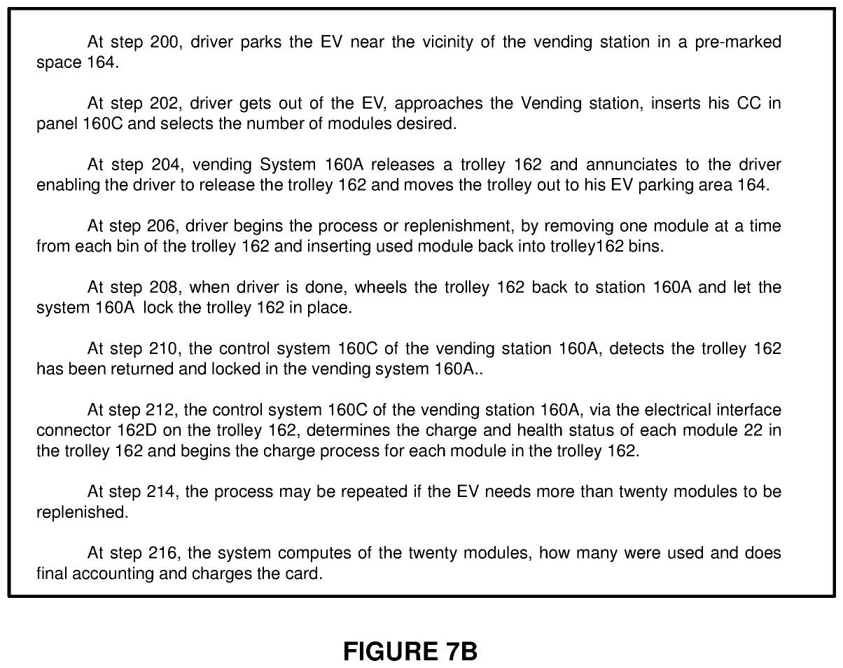

With reference to FIGS. 7A and 7B, a semi-automated vending system is described that can replenish the spent battery modules in the electric road vehicle in a matter of minutes.

### A System for Battery Charge Replenishment in Electric Road Vehicles.

A system 10, with reference to FIGS. 1A and 1B, is illustrated where a vehicle is shown with a plan view 10A and a side view 10B. The plan view 10A illustrates a battery module tray 12 positioned in the floor space of the vehicle, lithium ion cell batteries 14 placed in that tray 12, an access door 16 on the side of the vehicle that permits access to the battery tray 12. The side view 10B illustrates the vehicle has a vehicle frame 15B, a vehicle body 15A, and plurality of wheels 13.

The access door 16, as illustrated in FIG. 1B, is notionally 6 inches high and six feet wide and is present on both sides of the vehicle near the floor space of the vehicle. The specific sizes of the access doors 16 as above, is notional and would vary and change based on the design and structure of each electric vehicle and the floor space available for use for placement of battery modules in a specific model of the electric car.

As illustrated in FIG. 1B, in view 20A, enabling the battery tray 12 to be slid out to the left side 18A of the vehicle exposes half of the battery modules for access for replenishment. As illustrated in view 20B, slide out to the right side 18B of the vehicle, exposes the other half of the battery tray 12.

As illustrated in FIG. 1B, the battery tray 12 has a large number of batteries 14. This approach of accessing the battery tray 12 from both sides 18A and 18B of the vehicle maintains ease of access to the battery tray 12 without upsetting the balance of the vehicle. The battery tray 12 and its sliding rails are of construction that would support the weight of these batteries and make it convenient by an average driver to be able to slide out and slide in the battery tray 12 from either side of the vehicle.

In other embodiments (not illustrated), for convenience and ease of access, the battery tray 12 instead of being a single monolithic tray for this purpose may be physically partitioned into multiple trays.

As a simplified illustration in one of these embodiments, the tray 12 may be partitioned in four trays (not shown), where these four trays may be called front-left, front-right and rear-left and rear-right trays and where each of these trays may be independently accessed and moved out from inside the vehicle for the purpose of easy access of the battery modules therein.

In this embodiment each of these four trays may also have a mechanism and support system (not shown) to raise the height of each tray to a height that makes it convenient to access the tray without a driver's need to bend down to access the battery modules 14 in the battery tray 12.

In yet another embodiment, as a simplified illustration the tray 12 may be partitioned in six trays (not shown), where these six trays may be called left-front, left-middle, left-rear and right-front, right-middle and right-rear, where each of these trays may be independently accessed and moved out from inside the vehicle for the purposes of easy access.

In this embodiment each of these six trays may also have a mechanism and support system (not shown) to raise the height of each tray to a height that makes it convenient to access the tray without a driver's need to bend down to access the battery modules in the battery tray. There are prior art mechanisms that enable a tray structure to be slid open and then lifted up for ease of access, that are commonly used in warehouse storage system that may be adapted for the embodiments as described herein.

In the description, a lithium ion cell battery is identified as item 14 and a battery module made up from a collection of such cells, as described later with reference to FIG. 1C, is identified as a battery module 22.

Assuming a battery module 22 weighs seven pounds, one of these trays in a six tray structure would notionally be, ten battery modules per tray multiplied by seven pounds, equal to seventy pounds. There are prior art mechanisms that fold and unfold and enable a tray structure to be slid open and then raised up that may be advantageously used, for easy access of the battery module contents of the tray. Such prior art mechanism are used in warehouse applications.

An electronic status panel inside the vehicle may show the status of each of the six trays, in terms of the tray is present, tray is either open or closed, and tray door is latched for safety purposes.

There may be other ways to position the battery cells 14 that provide easy access to such battery modules 22 for swapping them out and these are not ruled out. As a simplified illustration, these batteries 14 may be positioned in trunk spaces either in the front or the back or both as long as the use of such spaces are practical from space usability, weight distribution and vehicle balance requirements.

As illustrated with the help of FIG. 1C, the batteries 14 in the battery tray 12, as illustrated earlier with reference to FIG. 1A, are configured to be used via battery modules 22. In a preferred embodiment, each battery module 22 has been configured to notionally hold 108 cells, enabling the battery module 22 to notionally weigh 7 lbs, have notional dimensions of 6″ by 12″ by 4″ and further enabling each battery module 22 to be physically accessed and then removed from the battery tray 12.

In a preferred embodiment each battery 14 in battery module 22 is a lithium ion cell with 3.7 Volts and 3000 mAH capacity. In a simplified illustration, with 108 cells in the battery module 22, the power stored in each battery module 22 would be equal to 108×3.7 V×3000 mAH=1.2 KWH.

Sixty such battery modules 22 in the battery tray 12 would have the power stored that would be equal to 72 KWH. Seventy-two such battery modules 22 in the battery tray 12 would have the power stored that would be equal to 85 KWH.

Therefore, notionally, such a battery module 22, as described above and in sufficient quantities based on electric vehicles of different sizes, capacities, and ranges would be viable use of the modular battery system of the embodiments described herein.

It is believed that the size dimension of each lithium ion cell of 3000 mAH capacity, notionally, is 2 inches by 3 inches and ⅓″ thickness. Thus 108 such cells can be accommodated in a battery module 22 notionally of size 6 inches wide, 12 inches long and a height of 4 inches.

The overall dimensions of the battery module 22, including the number of individual cells within each module 22 may be different then these weight and size dimensions as have been illustrated above and these are not ruled out.

As also illustrated with reference to FIG. 1C, further, each battery module 22 has a grip and a handle 26. In a preferred embodiment, the handle 26 performs three separate functions as described here. One of these functions of the handle 26 is to provide a handle for access and hold the module 22 from the front of the module to be used to hold and carry the module and push in and remove from a charging tray in a vending system as explained later with reference to FIG. 2A.

The second of these functions of the handle 26 is to provide access to the battery module 22 from the top or front of the battery module to be able to remove and reinsert a battery module 22 in the battery tray 12.

The third of these functions of the handle 26 is for the battery module 22 to be locked in place in the battery tray 12 so that the battery module is securely placed in a part of the battery tray 12.

It is believed that the DC electric motor 11, as in FIG. 1A, of the vehicle would operate either on 12 Volts or 24 volts. Therefore a group of these batteries 14 in a module 22 are connected in series to yield one of these voltages and these groups are then connected in parallel. It could be a different voltage as well such as 18 Volts, 30 Volts or 32 volts or 40 volts or 48 volts depending on the electric motor 11 selected for use in the vehicle.

As also illustrated with reference to FIG. 1C, in the battery module 22, indicator lights 24 are used that show the health and charge status of the module 22. The indicator lights 24 used in the module 22 are preferably LED lights that indicate the status of the module 22.

There may be four LED lights and these may be color coded so that a green light indicates a fully charged module 22, a red light indicated a fully depleted module, an orange light indicated a partially used module 22 and a purple light indicates that the module has undergone charge cycles that exceed a limit. The indicator lights 24 may be different than these and are not ruled out.

The indicator lights 24 are positioned both on the top as in the plan view 22A so that the module status is easily visible when the tray 12 is pulled out of the side of the vehicle and also on the front of the module 22 as illustrated in side view 22B, so that the lights 24 are easily visible on the module 22 when the module 22 is used in a vending station as illustrated later with reference to FIG. 2A.

The battery module 22 has a computer circuit board 25 and a plurality of interface socket connectors 27. The circuit board has a plurality of central processing units, random access memory, storage memory and a plurality of input and output interface processors, as well as other electrical circuit components. The circuit board is designed and configured for its intended application as detailed herein. In general computer circuit boards are a prior art that has been adapted to the specific application as described herein.

The circuit board 25 and the connectors 27 connect the batteries 14 of the battery module 22 via a harness (not shown) with a control circuit (not shown) that is used to power the electric motor 11 as well as provide other functions of an electric car.

The circuit board 25 also has logic to perform the functions for the indicator lights 24 as described earlier. There may be two connectors 27 that may be advantageously used where one connector may be used for charging the battery module 22 and the other connector may be used to draw power from the batteries 14 of the module 22. Yet another connector (not shown) may be used for diagnostic and maintenance purposes.

As illustrated with the help of FIG. 1D module use logic 30 in the vehicle decides how each module 22 in the battery tray 12 would be used to power the electric motor 11. It is believed, in prior art electric vehicles, the entire set of batteries is used as a single bank of batteries for powering the electric motor and also for charging the batteries.

In contrast in the embodiments described herein the individual batteries 14 that are physically configured in battery modules 22, are then electrically configured via the individual battery modules 22 to be used as an individual module one at a time for powering the electric motor 11 and also for charging individual modules 22 inside the vehicle, as has been further illustrated with the help of FIGS. 1D and 1E.

For powering the electric motor 11, a bank of two or even four modules may be used in parallel to provide sufficient power or amperage output for the electric motor 11. Since each cell 14 is rated 3000 mAH or 3 AH, a battery module 22 with 108 such cells would provide 108×3=324 Ampere Hours (AH) at 3.7 Volts.

Since the motor 11 would be rated for and most likely operate on much higher voltage, that is different than 3.7 volts, the individual battery cells 14 may be electrically connected inside the module 22 to provide, as simplified illustrations, 81 AH at 14.8 Volts or 40.5 AH at 29.6 Volts. If the power requirement of the electric motor 11 would be more than these values as above from an individual battery module 22, then a bank of 2 or 3 or 4 individual modules may be used in a bank for powering the electric motor 11.

The use of individual or a bank of battery modules is accomplished by use of logic 30, as illustrated in FIG. 1D. It is intended by the logic 30 that each module 22 or a bank of modules be fully used for powering the vehicle in a sequence enabling a module to be fully used before the logic uses the next module or a bank of modules in sequence. This makes it easier to replenish individual battery modules 22 at gas stations that provide a vending system for these battery modules 22.

This logic 30 enables the modules to be used in a sequence, enabling replacement of only the used modules, and thus incrementally charge modules of the vehicle at the vending system by replacing only the used modules.

As illustrated with the help of FIG. 1D, logic 30 provides functions of, where, function 30A checks module 1 status and if status is green, switch on module 1 to power motor 11; function 30B monitors module 1 status; function 30C, if module 1 is 50% depleted, then change module 1 color code to orange; function 30D, monitors module 1 status and If module 1 is 98% depleted then change module color code to red; function 30E, switches off module 1 & switches on module 2 for powering the electric motor 11. Function 30F repeats above functions 30A, 30B, 30C, 30D and 30E for other modules in sequence; for illustration from module 1 to module 72, if the vehicle has 72 battery modules 22.

The logic 30 would be equally applicable and would be adaptable where a bank of battery modules 22, such as 2, 3 or 4 battery modules is used in sequence for powering the electric motor 11.

As a simplified example, of the sixty battery modules in an electric car, if 15 of them have been used or discharged, then only these fifteen needs to be replaced with charged modules to provide full range capability. This is like the driver selecting how many gallons of gasoline to put in the car, based on how much is already in the tank and how far he/she has to go before refueling again.

With reference to FIG. 1E, status panels 32 that may be used in the vehicle are illustrated, where the status panels 32 may be positioned in a location that is accessible and visible to the driver. Status panels 32 in the vehicle help the driver to make such decisions related to, when and where to replenish the battery modules 22, for the electric car.

As a simplified illustration, based on assumed information, a Tesla car has a floor space size of approximately 5 ft by 6 ft or 30 square feet, holding a large number of individual cells. A Tesla car has 7400 cells. Assume that these 7400 cells are packed with a density of 7400 divided by 30 square feet or 245 cells per square feet. It is believed that this density and quantity of cells in a Tesla car provide a range of up to 300 miles.

The embodiment herein has described a battery module 22 with density of 108 cells per ½ square feet based on the size of the module, or 216 individual cells per square feet. These individual cells are packaged and arranged in 60 modules. As has been described earlier, each module 22 may be capable of providing 1.2 KWH, thus sixty battery modules 22 would be capable of providing a stored power of 72 KWH that is similar to what a Tesla battery pack is rated for. Therefore, sixty modules would provide a similar range of up to 300 miles or range of five miles per battery module 22.

FIG. 1E illustrates status panel displays inside the vehicle. As a simplified illustration display 32A shows a map of all the modules and their charge/discharge and health status. The status is displayed using color codes 34.

Status display 32B shows the relationship of green or fully charged modules in the battery tray 12 with the mileage available from these battery modules. This is similar to the gauges showing qty of gasoline in the tank and mileage available or miles to full discharge of battery modules like in a gasoline powered car.

Status panel 32C shows a map of available battery module vending stations, as has been described later. The vehicles pick up radio signals 40B from the vending stations in the vicinity notifying the vehicle of the availability of the battery module vending systems. Alternatively this information may also be received via satellite, as described later with referenced to FIGS. 5A, 5B and 5C.

There may be alternative embodiments in how the battery modules 22 are positioned inside the vehicle and they are not ruled out. In an electric car, many structures that are used in a gasoline powered car are dispensed with. Therefore, in an electric car, there is no engine, transmission and exhaust system, including mufflers and catalytic converters. That provides for considerable space savings that may used for positioning of the battery modules 22.

In an electric car there is an electric motor that is advantageously positioned in the rear of the car near the axle between the two rear wheels and thus is able to apply power directly to the rear wheels.

The front of the vehicle which had a gasoline engine is now empty and may be used for trunk space. One such system of positioning the battery modules (not shown) may use the space inside what used to be the engine compartment in a gasoline powered vehicle.

In one embodiment, the modules 22 may be positioned either in the trunk or under the hood. In addition the gasoline engine had considerable weight that is now not there. Hence the modules 22 may be positioned near the front of the vehicle between the dash board and the front wheels, in space that was used to house the gasoline engine and the transmission.

Such positioning of the modules 22 in the front portion of the vehicle would require a multiple tray structure (not shown) for holding a bank of sixty battery modules 22, that would be easily accessible to be able to reach and replace these modules 22.

Such a bank may have a rotatable structure of module bins to move a tray on the top for access to the modules in the top tray. It is assumed that each tray would hold 20 modules, based on the physical size of the battery modules, requiring 3 trays for 60 modules. These 3 trays would be arranged in a rotational structure enabling each tray to be moved up or down in the structure.

A user would be able to open a cover positioned between the windshield and the hood and access this rotational structure and access the bank of batteries and their individual battery modules 22 for easy access and replacement.

The battery modules 22 may be positioned both in the rear and front of the vehicle for easy access. They may be positioned in multiple banks, such as front bank and rear banks, in addition to a bank under the floor space.

There may also be an emergency bank holding as many as 2 to 4 battery modules that may be used to replenish these modules in an emergency. These emergency bank modules would enable a range of 20 miles or so until the vending system as described later with the help of FIG. 2A, is reachable. These emergency battery modules for use in emergency bank may be delivered by an emergency vehicle or stored in the electric car itself like a spare tire for use in an emergency.

FIG. 2A illustrates a vending system station with a vending rack 38 for the battery modules 22. The vending rack 38 is housed in a protective structure 36. The protective structure 36 or housing may be any location suitable for locating a battery module vending system and may be a structure such as a gas station or another structure such as a market. Alternatively or in addition, there may be new structures set up for this purpose.

The size of the vending rack 38 may notionally be 1 and ½ feet deep, height of 5 feet, and width of eight feet, making them suitable for use in a large number of locations such as gas stations and super markets with easy access to the electric vehicle. They may be different than this size or there may be multiple such vending racks 38 in a single structure 36.

The cost of replenishment of a battery module from such a vending system would be the cost of electricity to charge a module, cost of maintenance of such vending systems and a cost of doing business and profit. It is believed, that the cost of such a replacement battery module would nominally be a dollar or less, and where each module would provide a range of five miles, making electric vehicles refueling cost effectively comparable to gasoline powered vehicles.

As illustrated with the help of FIG. 2A, the vending station has a power source 42A from the electric grid and an inverter 42B to turn the power supply to DC, suitable for charging battery modules in the vending station.

The vending system rack 38 also has a vend-logic 50 that is described later with the help of FIG. 2B. Each battery module 22 is housed in its locked enclosure 44. The vend-rack 38 also has a vend-panel 46, and the vend-panel 46 has a display 46A and an insert bankcard slot 46B. The vending rack 38 is prior art technology except that it has been adapted for use in vending charged battery modules 22 and receiving discharged modules 22 for charging while in the vending rack 38.

Each vending rack 38 also has a wireless broadcast circuit 40A that wirelessly broadcasts location of the rack 38 as well as the availability of the charged battery modules. Such wireless signals are picked up by electric vehicles as has been described earlier with the help of FIG. 1E. The range of such wireless broadcasts may be limited to 5 to 25 mile radius to alert the electric vehicles to the availability of vending systems in the immediate vicinity of the electric vehicle, either in urban, rural or freeway areas.

FIG. 2B illustrates, with the help of logic functions 50A, 50B, 50C, 50D, and 50E, the vend-logic 50 that charges each of the modules 22 in the rack 38. As a simplified illustration, the vend-logic 50 sequences from module 1 to module N (assumed number of modules in the rack), and the logic checks each module, if the module is in place and is fully charged, is the module is currently being charged and if the module is not currently charging, to switch the DC power to charge this specific module.

The logic 50 then loops to the next module in sequence until all modules are covered and then the logic 50 repeats from module 1. Thus logic 50 enables the rack 38 to maintain the status of all removed and replaced modules with discharged modules constantly being charged from the electric grid, for next customer to use.

As also illustrated logic functions 50F and 50G wirelessly broadcast the data from each vending system rack 38.

With the help of FIG. 3A, how a vending rack 38 may be used in a gas station 70 is illustrated. A driver of the electric vehicle pulls alongside the vending system 38 and parks his/her vehicle there. The driver slides out the battery tray 12 and with the help of indicator lights as have been described earlier, is readily able to determine which of the 30 battery modules on this side of the vehicle are in need of replenishment.

FIG. 3A illustrates the method of replenishing each battery module 22. At step 1, a fresh battery module is removed from the vending station 38 and at step 2, temporarily placed on a holding tray 39. At step 3, the spent module from battery tray 12 is removed and inserted in the empty battery slot of the vending station 38. The vending station senses the insertion of the spent module, checks and closes the door. At step 4, the module 22 on the holding tray 39 is then picked up and inserted in the empty battery module slot in the battery tray 12 from where he/she had just removed the discharged module.

This process of retrieving charged battery modules from the vending system rack 38 is repeated for each discharged module in tray 12 giving the driver the flexibility to replace and replenish the number of modules that he/she needs for only the distance he/she needs to travel.

With help of FIG. 3B, an embodiment of a method on how the vending system stations are used is described with the help of vending logic 60.

At step 61, user drives up to vending system; opens up battery tray door; pulls out battery tray; and user sees modules with red light for replacement

At step 62, user activates vending logic; logic displays touch input panel; and user selects number of module to pay for.

At step 63, vending system selects the module slots and flashes them on the vending system

At step 64, user is instructed to insert bankcard; user inserts bankcard and logic show total to be charged.

At step 65, user opens flashing module slot on vending system; check charge status green; and removes module from slot and place the module on the shelf tray.

At step 66, user removes used module from battery tray; inserts used module in empty slot; and inserts module from tray to the battery tray.

At step 67, user repeats for other modules.

At step 68, user gets receipt; closes battery tray compartment; sits in driver seat and evaluate module status; and drives off.

FIG. 3C illustrates that after the required battery modules are replaced with the help of the vending station, the battery tray 12 is closed. FIG. 3D illustrates that the driver gets into the car and reviews the status panel 32A and status map 32B to review the status of the modules and available mileage. This is very similar to what a driver does in a gasoline powered car.

There may be different types of vending systems or dispense stations for battery modules than those described herein and they are not ruled out. As a simplified illustration, a gas station may store a large number of charged modules in a storage shed.

As one illustration, an employee of the gas station, when a driver drives his electric car to and parks in a defined area, the employee may load as many as 30 modules in a wheeled cart and wheel the cart to the vicinity of the electric car and replace the used modules in the electric car.

This dispense system as described above may be used alternatively or in conjunction with a vending system as has been described earlier. A vending system may be unattended and may operate 24 hours and seven days of a week providing a convenience to be able to refuel or charge the electric car any time.

As a simplified illustration, assuming ten electric cars drive into the gas station per hour and expect to replace all of their modules for a full range, then that would require the gas station to have six hundred charged modules at hand available per hour.

Assuming a charge or cycle time of one hour, an inventory of five hundred to a thousand modules may be adequate to serve all the ten electric cars that drive into the gas station for fully charging their electric cars by replacing all of their battery modules, while at the same time, the discharged modules received from other electric cars are also being charged by the vending system 38.

An inventory of five hundred to one thousand modules would require storage and charging space requiring use of a single bay in a garage at the gas station. Such a bay may be used from an existing bay or added as a new structure.

FIG. 4 illustrates the method 80 for replenishing the battery modules in the vehicle.
1. Providing battery compartment with left and right side slide out battery trays using access panel on the sides of the car.
2. Using modules in a sequence for powering the electric motor using module-use logic.
3. Displaying on the dashboard a status panel showing which modules have been depleted.
4. Driver reviewing mileage to destination status on the status panel. For determining need to replenish some or all of the battery modules.
5. Driver reviewing vending system map and deciding to arrive at the nearest vending system location.
6. Driver removing depleted modules and replacing with fresh modules from vending system and inserting used module in the vending system.
7. Driver paying for charged module from the vending system.

FIG. 5A describes an optional satellite based system 80. System 80 maintains database 86 of vehicles and their battery modules by serial number and charge status and number of charge cycles and database 88 of vending stations, their location and the serial number of battery modules and their charge status and number of charge cycles.

FIG. 5B illustrates a USA map that shows each vending station and the status of each station in terms of battery modules. This map is useful for maintenance purposes of the vending stations distributed over a large geographic area.

FIG. 5C illustrates a method for central system 80. Central system logic 90 is used to send and receive data to each vehicle 82 and each vending station 84.

At step 91, store in a database Electric Vehicle ID make and model and id of each battery module in each vehicle at the time of manufacture and delivery of electric vehicle to customer.

At step 92, store in a database, each vendor station location and id of each battery module in the vendor station.

At step 93, receive from each electric Vehicle green/orange/red status of modules.

At step 94, receive from each vendor station number of green/orange and red modules.

At step 95, send nearest vendor station data to each vehicle with module status of 50%.

At step 96, maintain charge cycles of each module in vehicle and vending station

### Alternative Vending System Embodiment 110 & 160

To improve for the driver of the electric road vehicle, the convenience of using the vending system as had been described earlier, with reference to FIGS. 2A and 2B, automated and semi-automated vending system embodiments 110 and 160 with the help of FIGS. 6A, 6B, 6C, 7A and 7B are herein described.

The embodiment 110 is a fully automated system using robotic arm technology where the driver does not even need to get out of his car, whereas, embodiment 160 described a semi-automated vending system using a system of trolleys to speed up replenishment of a large number of modules in a matter of minutes.

An alternative embodiment 110 for a battery module vending system using a robotic arm for battery module replenishment is illustrated with the help of FIGS. 6A, 6B, and 6C.

For embodiment 110, as illustrated in FIG. 6A, in view 110A, a different type of battery module holding structure is needed and such a module holding structure 112 is illustrated.

As illustrated in FIG. 6A, in view 110B, location of the holding structure 112 is in a position in space 116 in front of the vehicle in the engine compartment that has been vacated by dispensing with the gasoline powered engine.

As illustrated in FIG. 6B, in a plan view of the vending system 110, the battery modules from the space 116 in the front of the vehicle may be replaced by a robotic arm. The embodiment 110, using computer systems 126A and 126B coupled with robotic arms 130A and 130B is used to automatically remove the used battery modules from space 116 and retrieve fresh battery modules from the battery storage structures 124A and 124B.

As illustrated with the help of FIG. 6C, the computer system logic that is used in the embodiment 110 is described.

An advantage of this positioning of battery modules 22, as has been described here with the help of FIG. 6A is that such a positioning of battery modules 22 makes it possible to have a robotic arm coupled with a storage structure of modules 22, in a facility such as prior art gas stations or new stations and structures, as illustrated in FIG. 6B to automatically be able to remove and replace battery modules 22 in the vehicle 110B with the battery modules in the storage structures 124A and 124B of the vending system.

Thus this alternative embodiment 110 makes it possible to have the driver of the electric vehicle remain seated inside the vehicle 110B, while the robotic arms 132A and 132B automatically performs the task of swapping spent battery modules 22 in the vehicle 110B with replenished battery modules from storage structures 124A and 124B.

FIG. 6A provides a simplified illustration of a bank 112 of the battery module 22, where each of the battery modules 22 in bank 112 are arranged in a holding structure in a vertical orientation. As has been described earlier, a battery module 22 of the embodiments here is notionally 12 inches high, 6 inches wide and 4 inches wide.

In a vertical holding structure for battery bank 112, with a holding structure notional size of 36 inches wide, 40 inches deep and 15 inches high, a bank of sixty battery modules may be accommodated. This size of holding structure for battery bank 112 provides a surface area of 36×36 equal to 1440 square inches. This area divided by 24 inches, (the square area of a top of a battery module, 4 inches by six inches) equals 1440 divided by 24 equal to notionally sixty modules.

The holding structure 112 may be partitioned in two structures (not shown) positioned side by side, where the engine compartment has two gull shaped covers 130 as in FIG. 6B, that enable each structure to be reached by the robotic arm 132A and 132B.

As illustrated with the help of FIG. 6B, notionally, a driver of an electric vehicle 110B would drive into a bay 120 in an adapted gas station, that has been adapted to serve electric vehicles and park his/her car at an assigned mark line 132. The computer system 126A and 126B of the vending station would query the driver how many modules 22 need to be replaced. Alternatively this information may be automatically obtained from the vehicle by short distance wireless protocol means.

Dual computer systems 124A and 124B coupled with a robotic arms 132A and 132B, process this information and create battery module replacement program sequence that identifies the specific modules in the vehicle, their location, in the right or left bank, and the specific battery modules in the storage structures 124A and 124B, and uses this sequence to activate the robotic arms to perform the replacement task.

With reference to FIG. 6B, plan view of a bay area 120 is illustrated. The bay area 120 has an island 122A and an island 122B. These islands have module storage structure 124A and 124B and a computer system 126A and 126B and robotic arms 132A and 132B.

An electric vehicle 110B with a module storage structure 112 in front of the vehicle 110B drives into the bay 120, between islands 122A and 122B and stops until the vehicle 110B has reached marker line 132. The vehicle 110B has gull wing engine compartment doors 130 that provide convenient access to bank 112 for access by the robotic arms 132A and 132B.

As illustrated in FIG. 6C, the computer system 126 is illustrated along with the logic 144 operative in the memory and processor. The computer system 126 has CPU and memory 130; interfaces 142 and logic 144 with logic functions 1 to 18.

The interfaces 142 provide for four interfaces, wherein, the interface 1 is to the robotic arms 132A and 132B; the interface 2 is to the module storage structures 124A and 124B; the interface 3 is a wireless interface to the vehicle 110B and the driver; and the interface 4 is to the vehicle position and intake sensors in the bay 120 such as reference line 132.

Logic 144 functions are as follows:
1. Sense vehicle 110B is the bay 120.
2. Interface with vehicle, to determine type, battery modules and location and number of replacements.
3. Dialogue with driver to confirm intention and entry of bankcard data
4. Determine vehicle access compartments.
5. Intention Confirmed—number and location of modules and access compartments.
6. Read data from battery storage to determine which modules and their location for this customer.
7. Open and confirm access panel opened.
8. Command robotic arm to reach for and pull module 1 from vehicle.
9. Command arm to insert module in an empty slot.
10. Command arm to retrieve a module from the structure.
11. Command arm to insert the module in the slot in the vehicle.
12. Confirm proper electrical seating.
13. Repeat steps 8 to 12 for other modules.
14. Close access panel.
15. Repeat steps 7 to 14 for other panels, if any.
16. Alert Driver to confirm replacements in the status panel.
17. Confirm payment and task completion.
18. Alert the driver to drive out of the bay.

The underlying technology of computer systems, robotic arm and the storage structures is prior art and is widely used in many different kinds and types of manufacturing, including auto manufacturing and computer manufacturing for example. That prior art technology has been adapted to the specific application embodiment as described herein

With reference to FIGS. 6A, 6B and 6C, as above, a simplified illustration of a means of automatic replenishment of modules 22 in a vehicle 110B inside engine compartment 116, has been illustrated. Other similar embodiments are not ruled out.

### Vending System Alternative Embodiment 160

With the help of FIGS. 7A and 7B, an alternative embodiment 160 for a battery module vending station 160A using a semi-automated system for vending battery modules 22 for battery module replenishment in an electric vehicle is illustrated.

As illustrated in FIG. 7A, with a simplified illustration, in the semi-automated system embodiment 160, instead of the vending system dispensing, as has been described earlier with reference to FIG. 2A, individual battery modules from locked bins, the vending system in embodiment 160 vends a group of modules at one time, which are vended out of the vending system 160A in a movable cart or a trolley 162.

While this embodiment 160, as illustrated with the help of FIGS. 7A and 7B, provides a simplified illustration of a vending system using a system of trolleys, other similar systems are not ruled out.

As illustrated in FIG. 7A, the vending system 160A, has customer panel 160C and an electronics control system 160B. The vending system 160A has a number of trolleys 162 positioned near the bottom of the vending system 160A. Each trolley has a number of modules pre-placed in the trolley.

The trolleys 162 remain locked in place inside the vending system 160A using a locking system 164 until a customer has inserted his bankcard via the panel 160C and has programmed the customer panel with a selection of the number of modules desired. The system 160A unlocks the trolley 162 for moving away from the vending station 160A when a required number of battery modules in the trolley are in a charged state and a customer has been authorized to do so.

A user then can physically move or roll the trolley 162 to be near the vehicle location 168 and when is done swapping out the modules in his/her vehicle, moves the trolley 162 back into the vending station 160A for locking. This locking enables the vending system electronics 160B to count the number of modules returned and do a final cost calculation and charge the card.

The trolley 162 is movable to be positioned by the driver to be near an electric vehicle that has been parked 168 near the vending system 160A for quick replenishment of battery modules 22 in the electric vehicle. The trolley 162 is a part of the vending system 160A and is moved out away from the vending system 160A to be moved to the vicinity of the electric vehicle location 168 for convenience in replenishing multiple battery modules.

The vending station 160A has wireless connectivity (not shown) with the trolley 162 to control and manage the trolley 162 once it has been undocked from the vending station 160A.

Such control and management of the trolley 162 by the vending system 160A may include, (i) making sure the trolley does not leave a defined area, (ii) the number of modules removed, and used modules put back in the trolley. The control and management may include other functions such as how long the trolley 162 remains undocked from the vending system 160A. The trolley 162 may also optionally have and provide a voice interface feature (not shown) with the user to provide instructions and help in using the trolley 162.

The trolley 162 has individual open and accessible bins 162A that hold multiple battery modules, one battery module 22 in each bin 162A. There may be multiple rows 166B of bins stacked on top of each other 164, where each row has five bins holding ten battery modules. Similar row of bins are positioned on the other side 166A of the trolley. Thus the trolley 162 provides in this simplified illustration twenty bins and twenty battery modules. There may be more rows on each side providing a total of either twenty, or forty or sixty battery modules in one trolley 162.

The number of battery modules in the movable cart or trolley 162 may be as few as ten and as many as twenty, though they could be more or less then these numbers. That is, a customer when using the vending system 160, he/she selects the number of modules required, and pays with a bankcard, which is also used as security, until the trolley 162 is returned to the vending system 160, after having placed the used modules in the trolley.

The trolley 162 is of a height of 162B, has coasters 162C making it customer user friendly to be moved around the vehicle location 168 and access individual battery modules 22 from either side of the trolley 162.

The trolley 162 has electrical connectors and interface 162D, with a circuit board (not shown) and wiring harness (not shown) that provides electrical connectivity to each module 22 in the trolley 162. The electrical interface 162D is also used to electrically connect the trolley to the vending system 160A when the trolley 162 is moved back and locked inside the vending station 160A.

The trolley 162 has individual bins 162A and each bin is sized to receive and store a module 22 and each module is wired to a computer subsystem (not shown) in the trolley 162 and that computer subsystem communicates with the vending system computer system 160B to make sure that the trolley has been docked back to the vending system 160A.

Each module in the trolley also displays a health status of the module as has been described earlier with reference to FIG. 1C. That is, the charge status of each module in the trolley is clearly discernible to a customer when he removes a trolley from the vending station 160A and the customer can see that all the modules in the trolley are fully charged, when he has physically removed the trolley from the vending station 160A.

Also at the time of using the vending system and after having inserted the bankcard, the customer is notified, which specific trolley to remove from the station and how many modules does the specific trolley has that are fully charged.

The vending system has multiple trolleys so that multiple customers may be able to use the vending system 160 at the same time. It is envisioned that a vending system 160 may provide for either six or more such trolleys enabling up to six customers to use the vending systems 160A. It is assumed that it may take notionally 5 to 10 minutes using the semi-automated system 160 to replenish the vehicle with the required number of battery modules.

Each trolley 162 may notionally have as many as twenty modules that may be arranged in individual open ended bins arranged side by side and also stacked in rows of bins. As a simplified illustration, the trolley may have a top row of six bins and bottom row of six bins on one side of the trolley and a similar arrangement of bins on the other side of the trolley. Thus this trolley notionally would hold twenty-four modules.

The size of such a trolley notionally would be two feet wide, three feet long and three feet high, where the height is decided by the convenience of reaching each module without having to bend down below the waist. The size of the trolley is governed by the size of a module and thus size of a bin. The size of a bin notionally may be six inches wide, three inches high and twelve inches deep to accommodate a battery module as has been described earlier with reference to FIG. 1C.

The vending station 160A may have trolleys of different sizes to accommodate drivers who may have different types of electric vehicles and may need fewer or more modules to replenish their electric vehicles. As a simplified illustration a trolley may have a capacity of either having twenty, forty, or sixty modules. A mix of such different size trolleys may be vended by the vending station 160A, depending on the need of an electric vehicle driver.

Each trolley 162 is on a lockable set of wheels 162C enabling the trolley to be moved out away from the vending system 160A, moved to where the vehicle is parked. The trolley then may be moved around the vehicle area 168 to be near the access doors of the vehicle and then moved back to the vending station 160A and locked in place by the vending station.

Each trolley has an electrical interface connector 162D that interfaces to the vending system 160A management and control electronics 160B. The control electronics 160B manages each of the trolleys as well as the charge status of each of the modules in the trolley, when the trolley is docked to the vending systems 160A.

When the trolley is returned to the vending system and locked in place, the vending system then connects the trolley to the charging circuit for charging these modules in the trolley.

Therefore the vending station shows by indicators the charge status of each trolley by suitable means such as lights, where green light would indicate that the trolley is available for use, an orange light that the modules in the trolley are being charged as well as time in minutes required to charge the modules in the trolley.

Assuming as a simplified illustration, if the number of bins in the trolley are fixed such as at twenty, then user may use as many modules of these twenty modules as he/she wants to replenish his electric vehicle and return the trolley with a mix of unused and used up modules to the vending station.

FIG. 7B illustrates the logic and method steps for use of the vending system 160.

At step 200, driver parks the electrical vehicle near the vicinity of the vending station in a pre-marked space 164.

At step 202, driver gets out of the electrical vehicle, approaches the vending station, inserts his bankcard in panel 160C and selects the number of modules desired.

At step 204, vending System 160A releases a trolley 162 and annunciates to the driver enabling the driver to release the trolley 162 and moves the trolley out to his electrical vehicle parking area 164.

At step 206, driver begins the process or replenishment, by removing one module at a time from each bin of the trolley 162 and inserting used module back into trolley 162 bins.

At step 208, when driver is done, he/she wheels the trolley 162 back to station 160A and lets the system 160A lock it in place.

At step 210, the control system 160C of the vending station 160A, detects the trolley 162 has been returned and locked in the vending system 160A.

At step 212, the control system 160C of the vending station 160A, via the electrical interface connector 162D on the trolley 162, determines the charge and health status of each module 22 in the trolley 162 and begins the charge process for each module in the trolley 162.

At step 214, the process may be repeated if the electrical vehicle needs more than twenty modules to be replenished.

At step 216, the system computes of the twenty modules, how many were used and does final accounting and charges the card.

An electric vehicle for use by a user, the electric vehicle, comprising: a vehicle body that includes an access panel on an exterior of the vehicle body, the vehicle body includes a plurality of wheels; an electric motor that powers at least one of the wheels; a plurality of battery modules that supply electric power to the electric motor, wherein each battery module including a plurality of batteries; and a vehicle frame that retains the vehicle body, the vehicle frame including a holding structure that is accessible via the access panel, the holding structure retaining the plurality of battery modules, the holding structure being selectively movable between a first position in which the battery modules are positioned within the vehicle body, and a second position where the battery modules are positioned outside of the vehicle body for removable and replacement of individual discharged battery modules with charged battery modules.

The holding structure is positioned inside the electric vehicle in one or more of the spaces of, underneath the vehicle floor, in a front compartment, and in a rear compartment. The holding structure has rails that enable the holding structure to slide on the rails to move the holding structure out of the inside of the vehicle for access to the individual battery modules. The holding structure has a mechanism to prop up the holding structure for access to each of the battery modules.

The individual battery modules of the system of battery modules are connected via a wiring harness to a switch panel to power the electrical motor in a sequence until each individual battery module is discharged before switching to the next module in the sequence.

A computer system for managing a system of battery modules inside an electric vehicle, each battery module including a plurality of batteries, the computer system comprising: a central electrical switching panel; a wiring harness that connects separately each module to the central electrical switching panel; a first logic executing inside the computer system manages, via the central switching panel, each module separately by maintaining a charge status and a health status of each module; a second logic, where the individual battery module via the central switching panel, are electrically connected in a time sequence to power the electric motors until the individual battery module is discharged before switching on the next battery module in the sequence.

The second logic sequentially switches on a group of the modules to a plurality of electrical motors until each module is fully discharged, wherein when the charge status of a module being used to power the electrical motors falls below a threshold, the second logic switches on a next group of modules to power the electrical motors and so on in a sequence until all modules are fully discharged; a third logic in real time maintains charge status of each module and displays on a status panel positioned in the vicinity of the dash board;

The wiring harness includes two separate wiring harnesses, wherein a first harness is used for connecting the modules of the system of battery modules to the electric motors and a second wiring harness is used for charging the modules of the system of battery modules from a charging source.

Each module has an electrical circuit for managing status lights and display indicators, using a plurality of indicators, and includes status of, (i) charge remaining, (ii) number of recharge cycles, (iii) health status, and (iv) a machine readable make/model and a serial number.

Each battery module has two sets of status lights positioned on two different sides of the module, a front side and a top side, wherein the top side displays the status lights while the module is plugged inside the holding structure and the front side displays the status lights while the module is inserted in a vend system bin for recharging.

A system of battery modules inside an electric vehicle, comprising: the system of battery modules has individual battery modules in a holding structure and may range in number from 20 to 80; each module has a collection of cells, wired to each other in a series/parallel configuration to yield a current and voltage for powering an electric motor; a wiring harness connecting separately each module to a central electrical switching panel.

Each individual battery module has a circuit board with three outward facing electrical connectors; one electrical connector is for discharging the module for powering the electric motor, a second electrical connector is used for charging the module and a third electrical connector is used for providing visible health indicator lights on the module itself. Each individual battery module has a handle that is uses for access to the module for removal and insertion of the module from and to the holding structure. A locking mechanism using the handle for securely locking the battery module inside the holding tray is used.

A system for replenishing battery modules in an electric vehicle, comprising: a vend system (vend station) for battery module that vends a charged battery module and accepts a discharged battery module, for replenishing the battery module in an electric vehicle.

The vend system has a vend rack that holds in individual locked bins a number of such battery modules and a mechanism to vend a charged battery modules and accept a discharged modules in individual locked bin of the vend rack. The power source to charge the discharged battery modules in the vend rack. A wireless circuit that transmits the location of the vend station and the number of charged modules in the vend rack.

The vend machine, that accepts payment, selection of quantity of modules to be dispensed, activate the bin of the vending rack to be opened in defined a sequence for removal and insertion of used modules.

The vend system instead of individual battery modules in a locked bin in a rack, has a plurality of trolleys, wherein each trolley has a plurality of battery modules and the vending system vends a trolley; the trolley has coasters to be movable and to be positioned and moved to away from the vend system to be close to an electrical vehicle. Each trolley has wireless connectivity with the vend system for management and control of the trolley while away from the vend system.

While the particular invention, as illustrated herein and disclosed in detail is fully capable of obtaining the objective and providing the advantages herein before stated, it is to be understood that it is merely illustrative of the presently preferred embodiments of the invention and that no limitations are intended to the details of construction or design herein shown other than as described in the appended claims.

What is claimed is:

1. An electric vehicle for use by a user, the electric vehicle, comprising:
a vehicle body that includes an access panel on an exterior of the vehicle body, the vehicle body includes a plurality of wheels;
an electric motor that powers at least one of the wheels;
a plurality of battery modules that supply electric power to the electric motor, wherein each battery module including a plurality of batteries; and
a vehicle frame that retains the vehicle body, the vehicle frame including a holding structure that is accessible via the access panel, the holding structure retaining the plurality of battery modules, the holding structure being selectively movable between a first position in which the battery modules are positioned within the vehicle body, and a second position where the battery modules are positioned outside of the vehicle body for removable and replacement of individual discharged battery modules with charged battery modules.

2. The system as in claim 1, comprising:
the holding structure is positioned inside the electric vehicle in one or more of the spaces of, underneath the vehicle floor, in a front compartment, and in a rear compartment.

3. The system as in claim 1, comprising:
the holding structure has rails that enable the holding structure to slide on the rails to move the holding structure out of the inside of the vehicle for access to the individual battery modules.

4. The system as in claim 1, comprising:
the holding structure has a mechanism to prop up the holding structure for access to each of the battery modules.

5. The system as in claim 1, comprising:
individual battery modules of the system of battery modules are connected via a wiring harness to a switch panel to power the electrical motor in a sequence until each individual battery module is discharged before switching to the next module in the sequence.

6. A computer system for managing a system of battery modules inside an electric vehicle, each battery module including a plurality of batteries, the computer system comprising:
a central electrical switching panel;
a wiring harness that connects separately each module to the central electrical switching panel;
a first logic executing inside the computer system manages, via the central switching panel, each module separately by maintaining a charge status and a health status of each module;
a second logic, where the individual battery module via the central switching panel, are electrically connected in a time sequence to power the electric motors until the individual battery module is discharged before switching on the next battery module in the sequence.

7. The computer system as in claim 6, comprising:
the second logic sequentially switches on a group of the modules to a plurality of electrical motors until each module is fully discharged, wherein when the charge status of a module being used to power the electrical motors falls below a threshold, the second logic switches on a next group of modules to power the electrical motors and so on in a sequence until all modules are fully discharged;

8. The computer system as in claim 6, comprising:
a third logic in real time maintains charge status of each module and displays on a status panel positioned in the vicinity of the dash board;

9. The computer system as in claim 6, comprising:
the wiring harness includes two separate wiring harnesses, wherein a first harness is used for connecting the modules of the system of battery modules to the electric motors and a second wiring harness is used for charging the modules of the system of battery modules from a charging source.

10. The computer system as in claim 6, comprising:
each module has an electrical circuit for managing status lights and display indicators, using a plurality of indicators, and includes status of, (i) charge remaining, (ii) number of recharge cycles, (iii) health status, and (iv) a machine readable make/model and a serial number.

11. The computer system as in claim 6, comprising:
each battery module has two sets of status lights positioned on two different sides of the module, a front side and a top side, wherein the top side displays the status lights while the module is plugged inside the holding structure and the front side displays the status lights while the module is inserted in a vend system bin for recharging.

12. A system of battery modules inside an electric vehicle, comprising:
the system of battery modules has individual battery modules in a holding structure and range in number from 20 to 80;
each module has a collection of cells, wired to each other in a series/parallel configuration to yield a current and voltage for powering an electric motor;
a wiring harness connecting separately each module to a central electrical switching panel.

13. The system as in claim 12, comprising:
each individual battery module has a circuit board with three outward facing electrical connectors;
one electrical connector is for discharging the module for powering the electric motor; a second electrical connector is used for charging the module and a third electrical connector is used for providing visible health indicator lights on the module itself.

14. The system as in claim 12, comprising:
each individual battery module has a handle that is uses for access to the module for removal and insertion of the module from and to the holding structure.

15. The system as in claim 12, comprising:
a locking mechanism using the handle for securely locking the battery module inside the holding tray.

16. A system for replenishing battery modules in an electric vehicle, comprising:
a. a vend system (vend station) for battery module that vends a charged battery module and accepts a discharged battery module, for replenishing the battery module in an electric vehicle.
b. the vend system has a vend rack that holds in individual locked bins a number of such battery modules and a mechanism to vend a charged battery modules and accept a discharged modules in individual locked bin of the vend rack.

17. The system as in claim 16, comprising:
power source to charge the discharged battery modules in the vend rack.

18. The system as in claim 16, comprising:
a wireless circuit that transmits the location of the vend station and the number of charged modules in the vend rack.

19. The system as in claim 16, comprising:
a vend machine, that accepts payment, selection of quantity of modules to be dispensed, activate the bin of the vending rack to be opened in defined a sequence for removal and insertion of used modules.

20. The system as in claim 16, comprising:
the vend system instead of individual battery modules in a locked bin in a rack, has a plurality of trolleys, wherein each trolley has a plurality of battery modules and the vending system vends a trolley;
the trolley has coasters to be movable and to be positioned and moved to away from the vend system to be close to an electrical vehicle;
each trolley has wireless connectivity with the vend system for management and control of the trolley while away from the vend system.
